(19) United States
(12) Patent Application Publication
(10) Pub. No.: US 2005/0275303 A1
(43) Pub. Date: Dec. 15, 2005

(54) Differential flux permanent magnet machine

(76) Inventor: Michael Edward Tetmeyer, Hudson, OH (US)

Correspondence Address: DINSMORE & SHOHL LLP;One Dayton Centre, Suite 1300, One South Main Street, Dayton, OH, 45402-2023, US

(21) Appl. No.: 11/148,592

(22) Filed: Jun. 9, 2005

Related U.S. Application Data
(60) Provisional application No. 60/578,215, filed on Jun. 9, 2004.

(51) Int. Cl. H02K 17/00; H02K 37/00

(52) U.S. Cl. 310/166

(57) ABSTRACT

A differential flux motor includes a rotor and a stator assembly. The rotor has a shaft and rotor section(s) attached to the shaft. The stator assembly has first and second stator cores, first and second magnets, and a shell. The first stator core includes a first winding and concentrically surrounds at least a portion of the rotor. The second stator core has a second winding and concentrically surrounds at least a different portion of the rotor. The first magnet concentrically surrounds at least part of the first stator core, and the second magnet concentrically surrounds at least part of the second stator core. The first and second magnets are formed from permanent magnet material and have opposite polarities. The shell concentrically surrounds at least part of each of the first magnet and the second magnet. A method of manufacturing a differential flux motor is also provided.

### RELATED APPLICATION

The present application claims priority of U.S. Provisional Application Ser. No. 60/578,215 filed Jun. 9, 2004 and hereby incorporates the same Provisional Application by reference.

### TECHNICAL FIELD

The present invention relates to motors, particularly motors having a stator assembly including permanent magnets.

### BACKGROUND OF THE INVENTION

Many types of electric motors are available in the marketplace, all of which have certain advantages and disadvantages for particular applications. For example, a standard induction type motor is inexpensive, low-maintenance, and can be started without use of a motor controller (e.g., a variable frequency drive). However, unless a motor controller is connected to such an induction motor, precise speed regulation is not possible when the motor is subjected to loading.

Alternatively, an alternating current synchronous type motor can maintain precise speed regulation, even under loading. However, a motor controller must often be used with these motors to facilitate starting, and these motors are often relatively expensive due to their rotors incorporating compact, high-powered permanent magnets.

A synchronous reluctance type motor provides the benefit of being able to achieve precise speed regulation, even without use of a motor controller and without any need for permanent magnets. However, these motors are generally relatively inefficient.

Accordingly, there is a need for a relatively inexpensive motor which can be efficiently operated and which can achieve precise speed regulation without use of a motor controller.

### SUMMARY OF THE INVENTION

Accordingly, it is an aspect of the present invention to provide a relatively inexpensive motor which can be efficiently operated and which can achieve precise speed regulation without use of a motor controller.

To achieve the foregoing and other aspects, and in accordance with the purposes of the present invention defined herein, a differential flux motor is provided. In accordance with one embodiment of the present invention, a differential flux motor comprises a rotor and a stator assembly. The rotor comprises at least one rotor section and a shaft. The rotor section(s) is/are attached to the shaft. The stator assembly comprises a first stator core, a second stator core, a first magnet, a second magnet, and a shell. The first stator core includes a first winding and concentrically surrounds at least a first portion of the rotor. The second stator core has a second winding and concentrically surrounds at least a second portion of the rotor. The second portion is different from the first portion. The first magnet concentrically surrounds at least part of the first stator core. The first magnet is formed from permanent magnet material and has a first polarity. The second magnet concentrically surrounds at least part of the second stator core. The second magnet is formed from permanent magnet material and has a second polarity. The shell concentrically surrounds at least part of each of the first magnet and the second magnet.

In accordance with another embodiment of the present invention, a differential flux motor is provided that is configured to receive three phase alternating current having a substantially sinusoidal waveform. The motor comprises a rotor and a stator assembly. The rotor comprises a first rotor section, a second rotor section, and a shaft. The first rotor section and the second rotor section are spaced from one another along a longitudinal length of the shaft and are each attached to the shaft. The stator assembly comprises a first stator core, a second stator core, a first magnet, a second magnet, a first magnetic conductor ring, a second magnetic conductor ring, and a shell. The first stator core includes a first winding and concentrically surrounds at least part of the first rotor section. The second stator core has a second winding and concentrically surrounds at least part of the second rotor section. The first magnet concentrically surrounds at least part of the first stator core. The first magnet is formed from permanent magnet material and has a first polarity. A second magnet concentrically surrounds at least part of the second stator core. The second magnet is formed from permanent magnet material and has a second polarity. The second magnet is spaced from the first magnet. A first magnetic conductor ring is concentrically disposed between the first stator core and the first magnet. A second magnetic conductor ring is concentrically disposed between the second stator core and the second magnet. The second magnetic conductor ring is spaced from the first magnetic conductor ring. A shell concentrically surrounds at least part of each of the first magnet and the second magnet.

In accordance with yet another embodiment of the present invention, a method of manufacturing a differential flux motor is provided. The method comprises providing a rotor by connecting a first rotor section and a second rotor section to a shaft such that the first rotor section is spaced from the second rotor section. At least part of the first rotor section is surrounded with a first stator core having a first winding. At least part of the second rotor section is surrounded with a second stator core having a second winding. At least part of the first stator core is surrounded with a first magnet formed from permanent magnet material and having a first polarity. At least part of the second stator core is surrounded with a second magnet formed from permanent magnet material and having a second polarity. At least part of each of the first magnet and the second magnet are surrounded with a shell. The rotor is rotatably supported with respect to the first stator core, the second stator core, the first magnet, the second magnet, and the shell.

The motors described herein are advantageous for providing a relatively inexpensive motor which can be efficiently operated and which can achieve precise speed regulation without use of a motor controller. Additional aspects, advantages, and novel features of the invention will be set forth in part in the description that follows, and in part will become apparent to those skilled in the art upon examination of the following or may be learned with the practice of the invention. The aspects and advantages of the invention may be realized and attained by means of the instrumentalities and combinations particularly pointed out in the appended claims.

### BRIEF DESCRIPTION OF THE DRAWINGS

While the specification concludes with claims particularly pointing out and distinctly claiming the present invention, it is believed that the same will be better understood from the following description taken in conjunction with the accompanying drawings in which:

FIG. 1 is a front perspective view of a first rotor section in accordance with one embodiment of the present invention;

FIG. 2 is a front perspective view of a rotor in accordance with one embodiment of the present invention and depicting the first rotor section of FIG. 1 attached to a shaft;

FIG. 3 is a front perspective view of a first stator core in accordance with one embodiment of the present invention;

FIG. 4A is a front perspective view depicting a portion of the first rotor of FIG. 2 as partially assembled with the first stator core of FIG. 3 and other components;

FIG. 4B is a side view depicting the components of FIG. 4A as assembled;

FIG. 4C is a front view depicting the components of FIGS. 4A and 4B as assembled;

FIG. 5A is a partially exploded front perspective view depicting a differential flux motor in accordance with one embodiment of the present invention and including the components depicted in FIGS. 1-3, 4A, 4B, and 4C;

FIG. 5B is a partially exploded front perspective view depicting the differential flux motor of FIG. 5A as more fully assembled;

FIG. 5C is a front perspective view depicting the differential flux motor of FIGS. 5A and 5B as fully assembled;

FIG. 6A is a schematic diagram depicting magnetic flux flow among certain components of a differential flux motor in accordance with the teachings of the present invention, wherein a first rotor section is in a first position;

FIG. 6B is a schematic diagram depicting magnetic flux flow among certain components of the differential flux motor of FIG. 6A, wherein the first rotor section is in a second position;

FIG. 6C is a schematic diagram depicting magnetic flux flow among certain components of the differential flux motor of FIGS. 6A and 6B, wherein the first rotor section is in a third position;

FIG. 6D is a schematic diagram depicting magnetic flux flow among certain components of the differential flux motor of FIG. 6B, wherein windings are additionally shown;

FIG. 6E is a schematic diagram depicting magnetic flux flow among certain components of the differential flux motor of FIG. 6D, wherein a magnetic conductor ring is additionally shown;

FIG. 7A is a cutaway side view generally depicting a differential flux motor in accordance with the teachings of the present invention and having certain similarities to that depicted in FIG. 5C;

FIG. 7B is a semi-transparent perspective view depicting a differential flux motor in accordance with the teachings of the present invention and having certain similarities to that depicted in FIG. 5C, wherein the permanent magnet flux path is depicted;

FIG. 7C is a front perspective view of the rotor of FIG. 2 wherein a configuration of permanent magnet flux linking the rotor and stator core windings is depicted;

FIG. 8A is a cutaway end view of selected components of the differential flux motor of FIG. 5C wherein the stator core windings are open circuited;

FIG. 8B is a cutaway end view of selected components of the differential flux motor of FIG. 5C wherein the magnet is removed;

FIG. 8C is a cutaway end view of selected components of the differential flux motor of FIG. 5C illustrating the interaction of the permanent magnet and stator core winding magnetic sources to produce mechanical torque on the rotor;

FIG. 9A is a generalized front perspective view of a rotor in accordance with one embodiment of the present invention and having certain similarities to that depicted in FIG. 2, wherein a configuration involving individual stator core windings per rotor stack is depicted;

FIG. 9B is a generalized front perspective view of a rotor in accordance with one embodiment of the present invention and having certain similarities to that depicted in FIG. 2, wherein a configuration involving a single stator core winding is depicted;

FIG. 9C is a generalized front perspective view of a rotor in accordance with one embodiment of the present invention and having certain similarities to that depicted in FIG. 2, wherein a configuration involving a single stator core winding and an individual rotor stack rotated 90 degrees is depicted;

FIG. 9D is a cutaway end view of a differential flux motor in accordance with the teachings of the present invention, wherein its rotor sections are rotated 90 degrees respectively;

FIG. 10A is a cutaway end view of a differential flux motor illustrating flux paths therein;

FIG. 10B is a cutaway end view of a differential flux motor illustrating the use of rotor punch-outs and a separated rectangular shaft used to inhibit flux flow produced by stator core windings;

FIG. 11 is a cutaway end view of a differential flux motor depicting the spatial coordinate system chosen to derive equations for the differential flux motor;

FIG. 12 is a cutaway end view of a differential flux motor depicting the presence of Q-axis flux and D-axis flux;

FIG. 13 is a cutaway end view of a differential flux motor depicting permanent magnet flux;

FIG. 14 is a cutaway end view of a differential flux motor depicting flux linkage mutually circulating between stator core windings and generated by current flow in the stator core windings;

FIG. 15 is a cutaway end view of a differential flux motor depicting self-induced flux from each winding flowing along the same path as the permanent magnet flux;

FIG. 16 is a cutaway end view of a differential flux motor which depicts inclusion of barriers to the flow of circulating flux;

FIG. 17 is a cutaway end view of a differential flux motor which illustrates a typical three-phase winding orientation;

FIG. 18 is a graph depicting quadrature axis flux linkages as the rotor of a differential flux motor rotates;

FIG. 19 is a graph depicting torque produced by the direct axis winding with phase winding current held constant as the rotor position of a differential flux motor varies;

FIG. 20 is a graph depicting phase torque produced with a reduced reluctance torque component in a differential flux motor;

FIG. 21 is a graph depicting the permanent magnet flux linking phase “A” windings aligned with both the direct and quadrature axis as the rotor of a differential flux motor rotates;

FIG. 22 is a graph depicting back electromotive force voltages induced on phase windings of a differential flux motor as a result of permanent magnet flux and rotor rotation;

FIG. 23 is a graph depicting phase currents of a differential flux motor as a function of rotor position; and

FIGS. 24-92 depict equations used in describing a differential flux motor.

### DETAILED DESCRIPTION

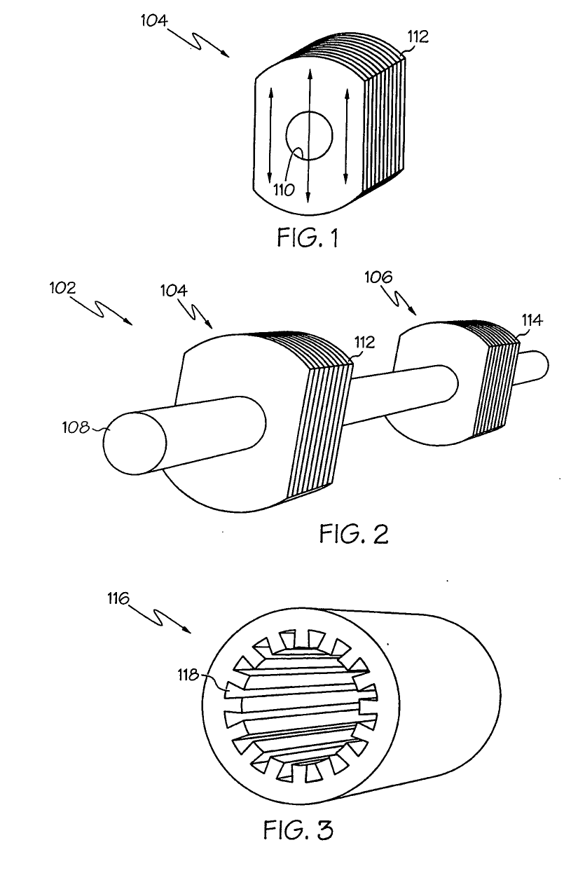

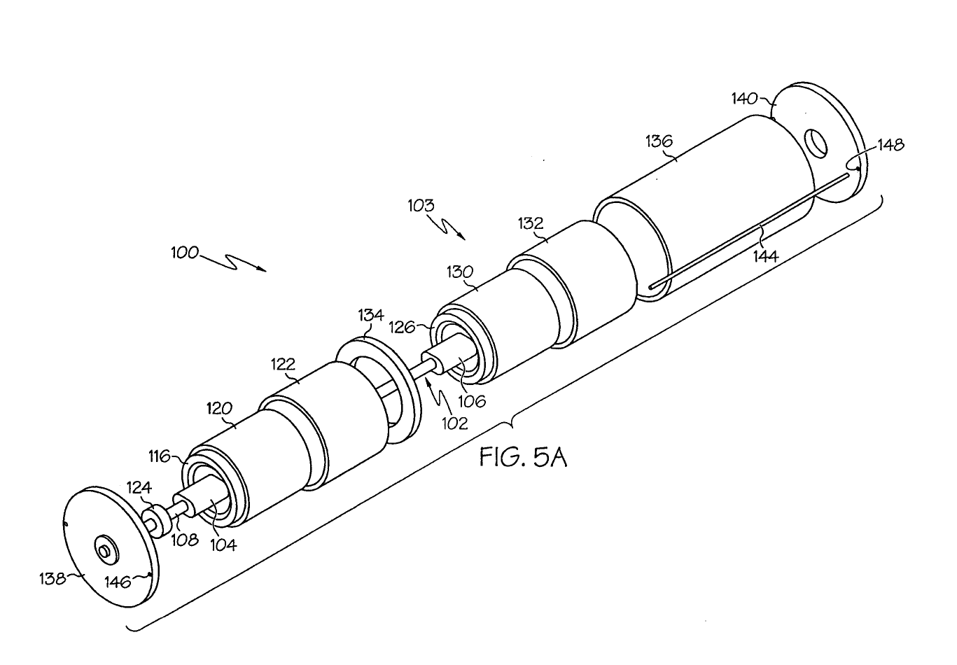

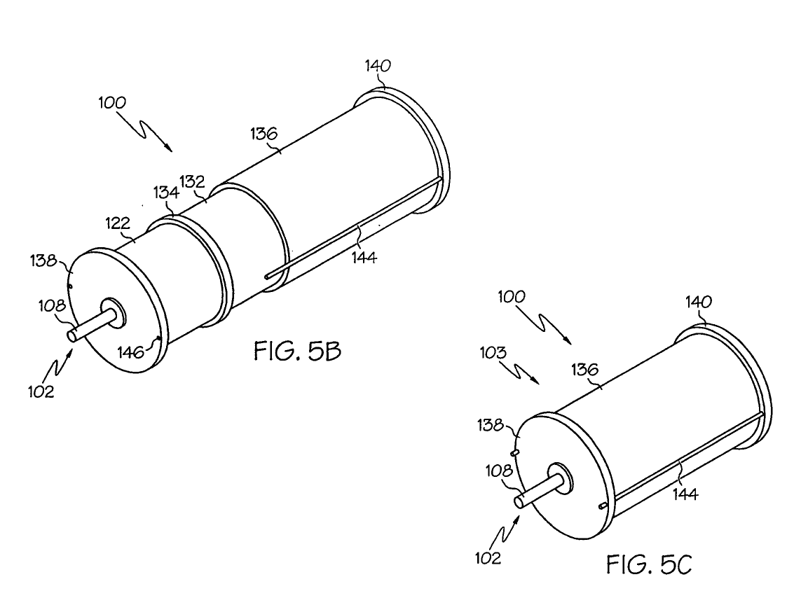

An embodiment of the invention and its operation is hereinafter described in detail in connection with the views and examples of FIGS. 1-92, wherein like numbers indicate the same or corresponding elements throughout the views. One differential flux motor in accordance with the teachings of the present invention is depicted in FIG. 5C as a motor assembly 100. The motor assembly 100 is shown in FIG. 5C to include a rotor 102 and a stator assembly 103. The rotor 102 includes a shaft 108 to which a pulley, gear, fan, or other driven device may be attached. The shaft 108 may be formed of a ferromagnetic material such as steel. The stator assembly 103 comprises a shell 136. The shell 136 can be cylindrical and can be formed from ferromagnetic material (e.g., a single piece of rolled steel). End plates 138, 140 can be provided and can be constructed of non-ferromagnetic material (e.g., aluminum) and can contain bearing seats and provisions (e.g., apertures 146, 148 shown in FIG. 5C) for bolts (e.g., 144) for fastening the entire motor assembly 100 rigidly together. The end plates 138, 140 are depicted as being associated with the stator assembly 103 for rotatably supporting the rotor 102 with respect to the stator assembly 103.

The motor assembly 100 is shown as being partially disassembled in FIG. 5B, and as being more fully disassembled in FIG. 5A. Referring now to FIG. 5A and also to FIG. 2, which depicts the rotor 102 apart from the stator assembly 103, the rotor 102 is shown to include a first rotor section 104 and a second rotor section 106, both of which are attached to the shaft 108 such that they are spaced from one another along the longitudinal length of the shaft 108 and rotor 102. Each of the first and second rotor sections 104, 106 are shown to comprise salient pole rotors (containing protruding poles) which can be formed from (and, possibly, exclusively from) thin sheets or laminations 112, 114 of grain-oriented ferromagnetic material (e.g., iron or electrical steel) oriented for maximum flux flow along the length of the lamination. Accordingly, as shown in FIG. 2, the rotor 102 can comprise two rotor lamination stacks (i.e.: the first and second rotor sections 104, 106) that are separately attached on a common shaft (i.e.: 108), thus creating a dual rotor pair or configuration.

FIG. 1 depicts the first rotor section 104 apart from the other components of the rotor 102. The first rotor section 104 is shown to include laminations 112 which have a central aperture 110 that is sized to accept the shaft 108. FIGS. 1 and 2 illustrate how thin iron laminations can be stamped into a simple shape consisting of two salient poles, and can then be stacked to form a rotor section. The magnetic grain of the laminations can be oriented lengthwise, as shown in FIG. 1, so that flux flows lengthwise across the lamination and to inhibit flux from flowing across the width of the lamination. It should be appreciated that in certain alternate embodiments of the present invention, a rotor might include only one rotor section as opposed to two distinct and separated rotor sections (e.g., 104 and 106 as shown in FIG. 2), or might alternatively include greater than two rotor sections.

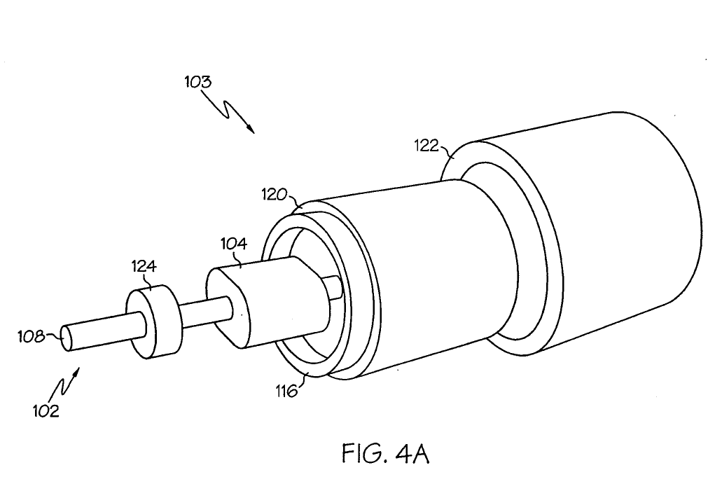

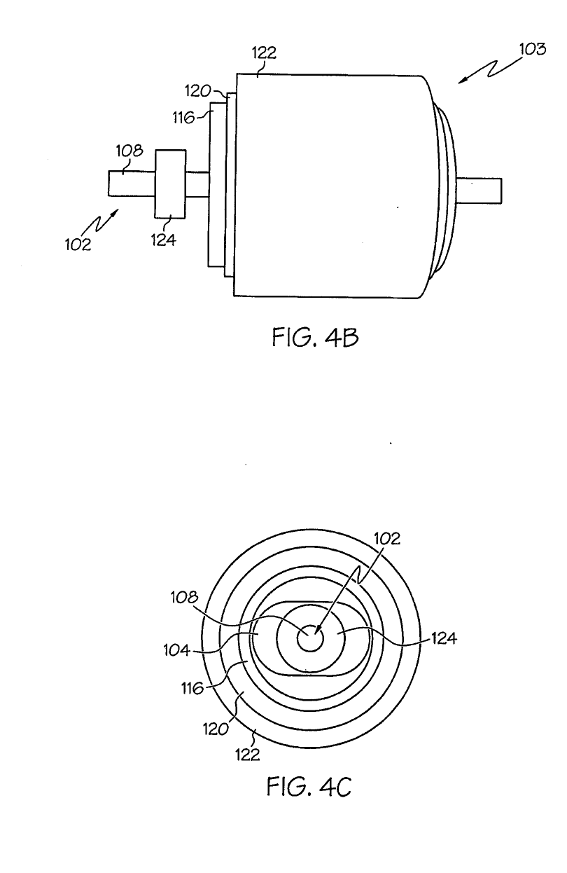

In addition to the shell 136, the stator assembly 103 can include additional components which concentrically surround the rotor 102. For example, as depicted in FIG. 5A, the stator assembly 103 can include a first stator core 116 which concentrically surrounds the first rotor section 104 of the rotor 102. The first stator core 116 is shown to be concentrically surrounded by a first magnetic conductor ring 120, then by a first magnet 122, and then by the shell 136. Likewise, the stator assembly 103 can include a second stator core 126 which concentrically surrounds the second rotor section 104 of the rotor 102. The second stator core 126 is shown to be concentrically surrounded by a second magnetic conductor ring 130, then by a second magnet 132, and then by the shell 136. The first and second magnets 122, 132 can be formed of permanent magnet material. In one particular embodiment, the first magnet 122 can be magnetized with uniform polarity around its entire circumference such that its flux is centrally directed, and the second magnet 132 can be constructed identically to the first magnet 122 except that its permanent magnet is magnetized in the opposite polarity such that its flux is outwardly directed. It should be appreciated that a magnet as described herein (e.g., the first and/or second magnet 122, 132) can be formed integrally (e.g., as a ring) or as a plurality of separate magnets (e.g., that might be disposed adjacently to create a ring). For clarity of illustration, FIG. 4A is provided to illustrate a relationship between selected components of the rotor 102 and certain components of the stator assembly 103 as partially disassembled. FIGS. 4B and 4C depict these same selected components as assembled.

Referring again to FIG. 5A, a spacer 134 can be provided between at least one of (a) the first magnet 122 and the second magnet 132, (b) the first magnetic conductor ring 120 and the second magnetic conductor ring 130, (c) the first stator core 116 and the second stator core 126, and (d) the first rotor section 104 and the second rotor section 106. As shown in FIG. 5A, the spacer 134 is shown to separate at least the first magnet 122 and the second magnet 132. In one embodiment of the present invention, the spacer 134 can be formed from a non-ferromagnetic material such as aluminum. In another embodiment of the present invention, a non-ferromagnetic aluminum spacer (e.g., 134) of the same shape as the stator cores can be used to magnetically separate the stator cores and simplify the winding assembly. It will be understood that the motor assembly 100 can be constructed without the first magnetic conductor ring 120 and/or the second magnetic conductor ring 130, and that the presence of these components might merely serve the purpose of increasing efficiency and/or performance of a motor assembly so equipped.

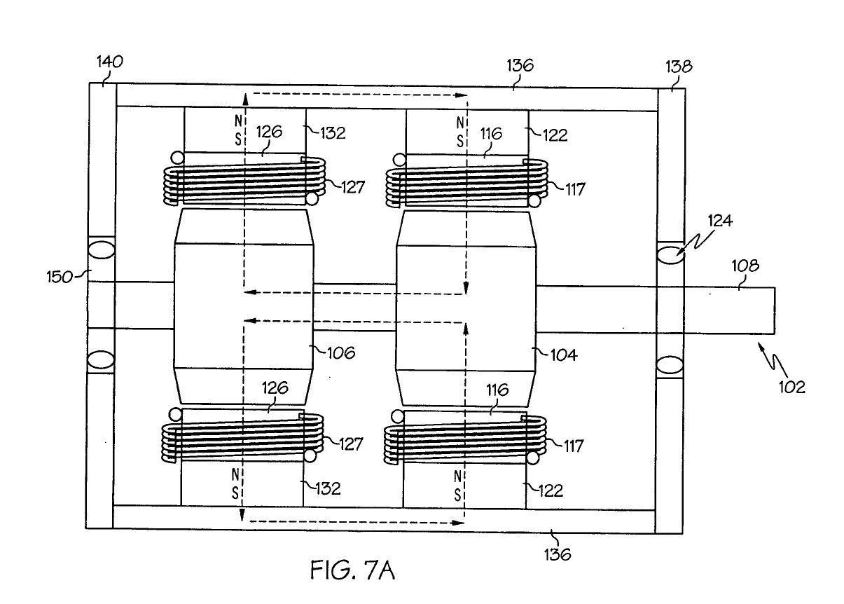

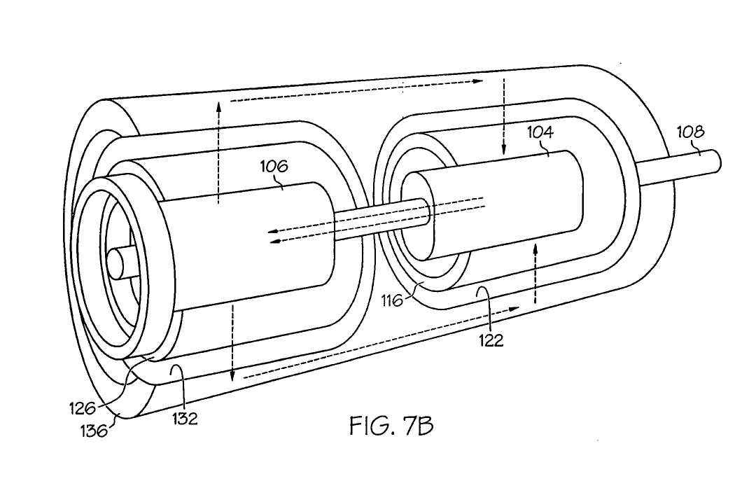

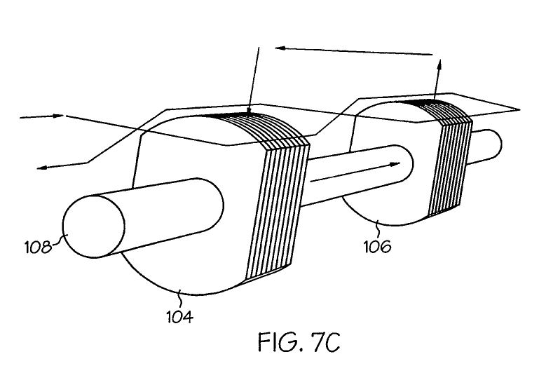

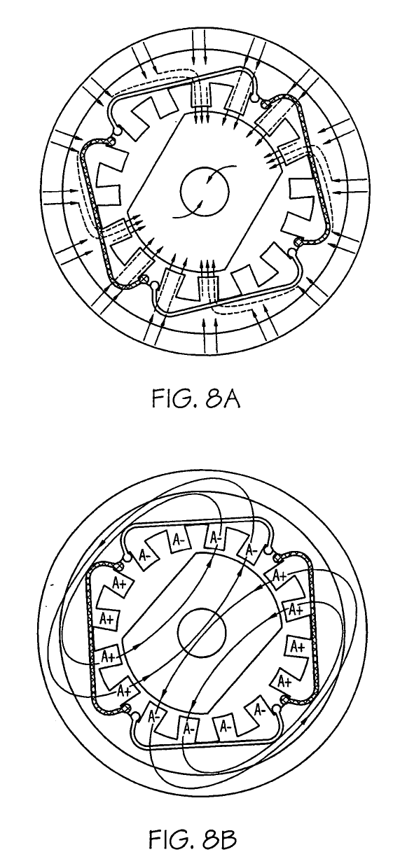

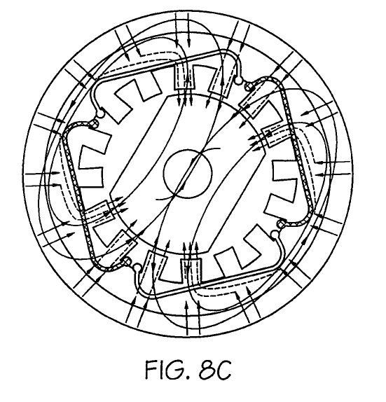

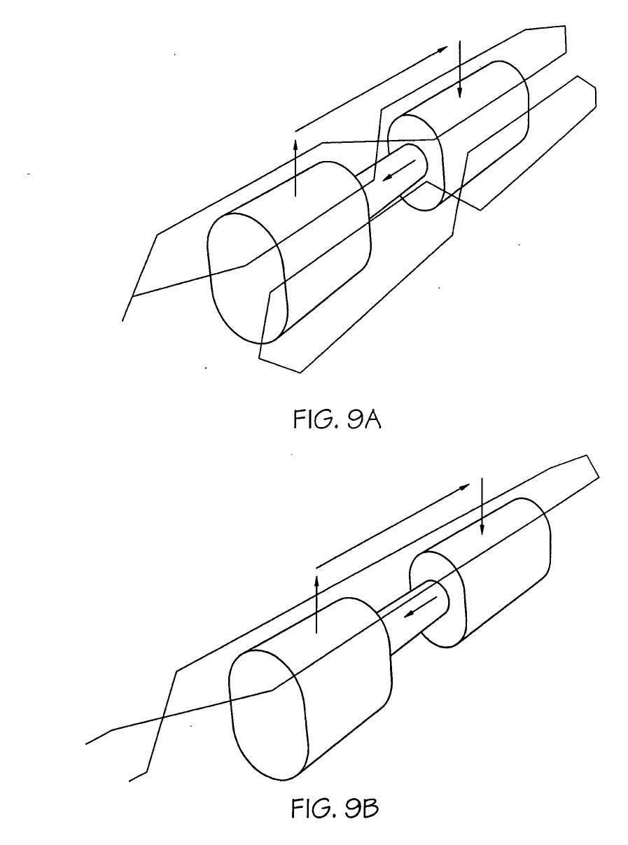

FIG. 5A further depicts a bearing 124 which can be provided to assist in suspending the shaft assembly 102 with respect to the end plate 138. A similar bearing (e.g., shown as 150 in FIG. 7A) may be provided to similarly assist in suspending the shaft assembly 102 with respect to the end plate 140. The bearings 124, 150 can be press fit onto the ends of the shaft 108. Apertures (e.g., 146, 148) are also depicted for receiving the bolts (e.g., 144) used to hold the end plates 138, 140 together against the shell 136 when the motor assembly 100 is assembled as shown in FIG. 5C.

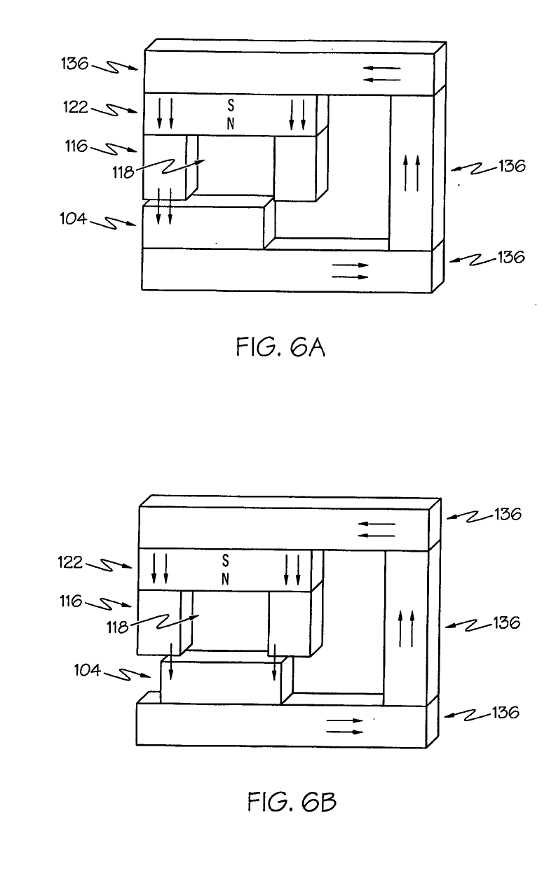

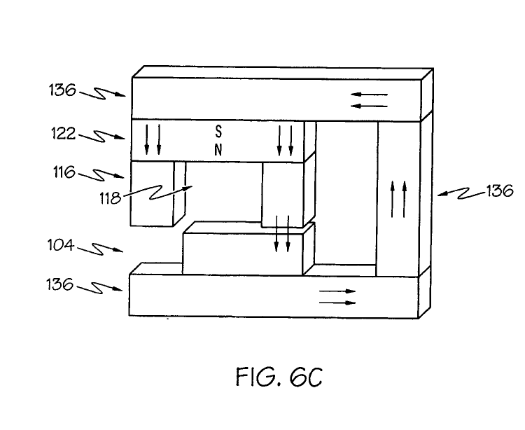

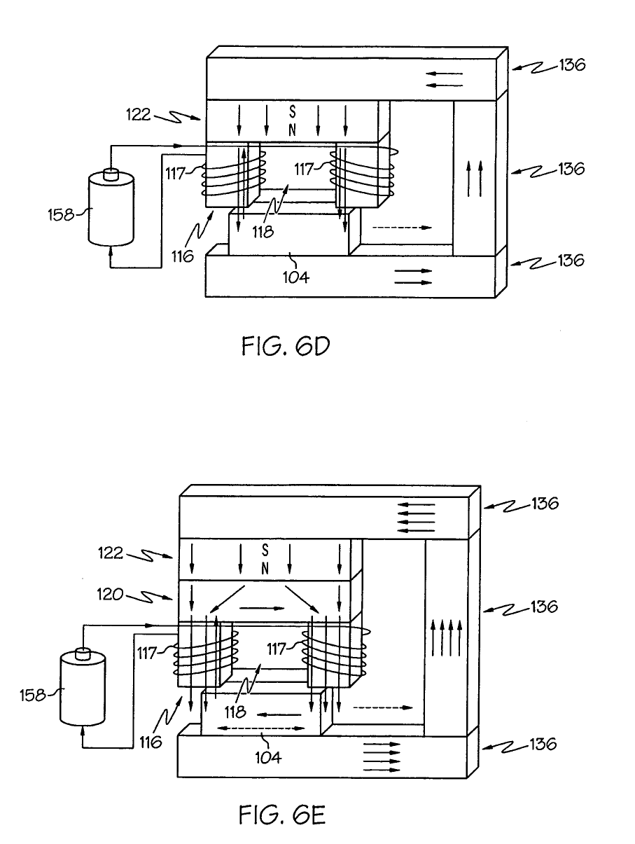

The first stator core 116 can be provided with a plurality of slots 118, as shown for example in FIG. 3. The slots 118 can be configured to receive electrical windings. Non-salient stamped laminations fabricated from electrical sheet steel can be stacked to create the first and second stator cores 116, 126. For example, standard four pole stator iron laminations can be stamped and stacked together to create the first and second stator cores 116, 126. Windings of wire can then be placed in the slots (e.g., 118) using conventional winding methods. The wire windings can be connected in a conventional manner to create four magnetic poles for operation from a sinusoidal alternating current supply (or from a substantially sinusoidal alternating current supply as would be generated by many motor controllers). In particular, FIGS. 6D, 6E and 7A depict windings 117 in association with the slots 118 of the first stator core 116. Likewise, FIG. 7A depicts windings 127 in association with the second stator core 126. For clarity of illustration, the slots and windings are not depicted in all of the views (e.g., FIGS. 4A, 4B, 4C, 5A and 5B). As will be appreciated, the first and second stator cores 116 and 126 can be provided with windings in any of a variety of specific configurations and patterns using conventional construction techniques. For example, the first and second stator cores 116, 126 can be wound conventionally to operate from a standard sinusoidal AC power source. Shorted conductors on the rotor can be added for starting the motor directly off the power grid by the principal of induction. As another winding option, the first and second stator coils of a differential flux motor could be wound to operate from a square or trapezoidal wave power source, and/or to operate from single phase, three phase, or some other phase configuration, and/or may include as few as two poles or as many poles as practicable.

The method of torque production in the differential flux motor differs from conventional methods of torque production for electric motors. Conventional methods of torque production use the principal of mutual flux or variable reluctance to generate torque. This paragraph describes the principal of torque production by differential flux. The permanent magnet source (i.e.: first and second magnets 122, 132) produces constant flux, which flows mutually through two independent variable magnetic sources (i.e.: first and second stator cores 116, 126). The two independent variable magnetic sources are constructed to produce magnetic force of equal magnitude but opposite polarity. The flux flowing through each independent source is the difference between the magnitude and polarity of the permanent magnet source and the independent magnetic source. The independent source with the same polarity as the mutual source assists the flow of permanent magnet flux, and the independent source of opposite polarity opposes the flow of permanent magnet flux. Thus, the independent sources tend to steer the flow of permanent magnet flux to either one independent magnetic source or the other.

FIG. 6A illustrates the concepts of torque production in the differential flux motor. The independent magnetic source is modeled by the permanent magnet of single polarity (shown as first magnet 122). The movable member (shown as rotor section 104) will gravitate toward the position that achieves maximum flux flow. The length of the movable member is chosen so the net overlap (surface area) between the movable member and the protruding poles (i.e.: the portions of the first stator core which extend to define the slot 118), and corresponding reluctance of the permanent magnet flux path, and corresponding permanent magnet flux, remains constant at any given position. Since the reluctance of the magnetic path is constant, the corresponding permanent magnetic flux flowing through the movable member is constant and independent of position, thereby producing no force on the movable member as illustrated in FIGS. 6A, 6B, and 6C.

The independent magnetic sources are modeled as two electromagnets with windings (shown as first winding 117) wound in opposite directions and connected in series as illustrated in FIG. 6D. Current flowing through the windings produces equal and opposite magnetic force. This construction forces the independent magnetic source to be of equal magnitude but opposite polarity. The electromagnet is activated when connected to a battery 158, thus producing equal and opposite magnetic forces. The movable member in the magnetic circuit will gravitate under mechanical force to the position of maximum flux (indicated by the dashed arrow) which is under the winding aiding the flow of permanent magnet flux. The magnitude of permanent magnet flux flow remains constant. If the current is reversed, the electromagnet polarities reverse, and the movable member gravitates in the opposite direction.

As illustrated in FIG. 6E, an additional magnetic member (e.g., shown as the first magnetic conducting ring 120) can be added under the permanent magnet (i.e.: 122). Adding such a magnetic path under the permanent magnet increases the magnitude of available permanent magnet flux by providing increased area for permanent magnet flux to flow. A magnetic path is also created for circulating flux produced by the electromagnet to flow in the windings, which is no longer impeded by the low permeability permanent magnet material. The magnitude of flux flowing through the movable member is a combination of the circulating flux produced by the electromagnets and the flux produced by the permanent magnet. The reluctance path for the circulating flux varies with position in an amount proportional to the amount of overlap of the magnetic member linking both windings. The overlap is maximum when the moveable member is midway between the two windings, and is minimum when the movable member is fully aligned under either winding.

Since the reluctance varies with position, the circulating flux produces a reluctance force on the movable member. The force is positive when reluctance (overlap) is increasing, and negative when reluctance (overlap) is decreasing. Therefore, the reluctance force applied to the movable member reverses direction as the movable member crosses the midway points of minimum and maximum overlap. Over the entire interval of motion, the net positive and negative reluctance force sums to zero. The oscillating reluctance force is thus twice the frequency of the force produced by differential flux action and therefore does not contribute to net force production. The same concept is applied to a radially constructed motor. A rotor with protruding poles will tend to align itself to the position achieving maximum flux flow. In the case of the motor assembly 100, the rotor pole will align itself under the independent source that assists the flow of the permanent magnet flux.

The differential method of torque production differs from the mutual flux method of torque production since an independent magnetic source is not required on the rotor. The differential method of torque production differs from the variable reluctance method since the reluctance of the magnetic path is constant and the stator magnetic poles are steering mutual permanent magnet flux through the protruding rotor pole instead of producing the flux flowing through the rotor poles.

The path of the permanent magnet flux is illustrated in FIGS. 7A, 7B, and 7C. The flux circulates down through the first winding 117 on the first stator core, into the protruding rotor poles of the first rotor section 104, along the length of the shaft 108, up through the protruding rotor poles of the second rotor section 106, up through the second winding 127 on the second stator core 126, and completes the path along the circumference of the shell 136. The flux generated by the first and second magnets 122, 132 flows common to all windings residing on both the first and second stator cores 116, 126. The net permanent magnet flux generated is constant and independent of rotor position since the stator contains no protruding poles. Therefore, the reluctance of the magnetic path is invariant with rotor position.

Torque production using fixed magnetic poles on the stator core (concentrated phase windings with switched square wave excitation) will now be discussed. For ease of reference, the magnetic poles of the stator core may sometimes hereinafter be referred to as stator magnetic poles. As illustrated in FIGS. 8A, 8B and 8C, a pair of wire windings connected in series can be placed on the stator 90 degrees apart. The windings can be wound in opposite respective directions. Therefore, uniform current flowing through the winding pair produces magnetic sources of equal magnitude but opposite polarity. The method of torque production, with the stator magnetic poles fixed in position (concentrated windings) is analyzed first to simplify conceptualization. The process of torque production is more clearly understood if the contribution to torque production by each magnetic source is analyzed independently, then dependently.

The analysis of the effect of the permanent magnet source is illustrated in FIG. 8A. If each individual concentrated winding is open circuited, current cannot flow in the windings, so the magnetic source produced by the windings is disabled. The arrows illustrate the portion of permanent magnet flux linking individual windings on the stator core which are spaced 90 degrees apart as the rotor rotates. Windings on a stator core may sometimes be hereinafter referred to as “stator windings.” The permanent magnet flux is uniform throughout the periphery of the stator core since the stator core is non-salient. Therefore, a change in rotor position does not produce any net change in permanent magnet flux. However, the portion of permanent magnet flux linking individual windings varies differentially with rotor position. The permanent magnet flux which links the winding is maximum when the protruding rotor pole fully aligns under the winding, and is minimum when unaligned with the winding. Therefore, as the rotor is rotated mechanically, a voltage is induced on the winding as permanent magnet flux varies through the winding, according to Faraday's law. As the rotor rotates, flux is decreasing in one winding while increasing in the opposite winding. The rate of change of flux is therefore equal and opposite in each winding of the pair. The pairs are wound in opposite directions. The two opposites (induced voltage and winding orientation) cancel to produce winding voltages of the same polarity. Motoring operation and torque production is obtained by injecting winding current in phase with the induced voltage.

To analyze the effect of the winding magnetic poles, the permanent magnets are removed from the illustration of FIG. 8B. A magnetic source of equal magnitude but opposite polarity is generated at the windings when current is injected into the winding pair. The arrows illustrate the path of flux produced by current flow in stator core windings. The flux produced is distributed unevenly in the stator core, circulating around the magnetic pole pairs. The flux mutually links both windings. The magnitude of flux generated by the windings depends on the relative rotor position and varies as the reluctance of the magnetic path linking both windings varies with rotor position. The protruding rotor pole will align itself midway between the magnetic poles of the stator core to form a region of maximum circulating flux linkage. The torque produced is of the variable reluctance type. The rotor will align to the same position regardless of the magnetic polarities of the stator core poles (direction of current flow through the winding pair). The grain-oriented type of rotor lamination reduces the permeability to circulating flux flowing in the tangential direction. Thus the magnitude of circulating flux, and corresponding reluctance torque, is reduced. To generate positive reluctance torque, current is injected in the winding when the rotor is fully aligned with the first winding. Torque production is positive until the rotor is aligned midway between the winding pair, then reverses direction as the rotor rotates away from the midway point.

To analyze the dependent condition, the permanent magnets are reattached to the stator core. FIG. 8C illustrates the interaction of the permanent magnet and windings to produce mechanical torque on the rotor. The permanent magnet flux forms a constant uniform bias flux flowing through the windings. A magnetic source of equal magnitude but opposite polarity is generated at the stator core poles when current flows into the winding pair. Current flowing through the windings produces a magnetic source which interacts with the permanent magnet. The equal and opposite magnetic sources oppose the flow of permanent magnet flux in one stator core winding and aids the flow of permanent magnet flux in the opposite winding. The net effect of the current flowing through the winding pair is to steer the permanent magnet flux towards one winding or the other. Flux also circulates between the windings, linked by the magnetic path provided by the protruding rotor poles. Torque is produced as the protruding rotor pole rotates to achieve maximum flux flow through the rotor pole.

If the rotor pole protrusion is fully aligned under the first winding of the pair, current is injected in the winding producing a magnetic source which opposes the flow of permanent magnet flux. If the thickness of the permanent magnet is sufficient to provide near constant flux, the opposing stator core flux slightly reduces the magnitude of permanent magnet flux flowing through the rotor pole protrusion. The rotor will start rotating towards the second winding to achieve maximum flux through the rotor pole. The flux flowing through the rotor will increase as the rotor rotates towards the opposing stator core pole, thereby aiding the flow of permanent magnet flux.

The differential flux produced from current flow in the individual winding flows in the same magnetic path as the permanent magnet flux. Thus, the flux is flowing mutually through the winding and the permanent magnet. The magnetic source produced by injecting current flow in the winding alters the airgap distribution and flow of permanent magnet flux. The magnitude of permanent magnet flux fluctuation is proportional to rotor position and winding current magnitude. This fluctuation of flux is detrimental to the permanent magnet and contributes to power losses from eddy currents in the ferromagnetic shaft and shell of the motor. Thus, the rotor will align to the position that achieves maximum flux flow through the rotor which is fully aligned under the stator core winding aiding the flow of permanent magnet flux.

Now explained is how the use of rotating stator magnetic poles significantly reduces the magnitude of flux fluctuation through the permanent magnet. As the rotor rotates, a path is created for flux produced by the windings to circulate between the winding pairs. The rotor rotates to the position to achieve maximum flux flowing through the protruding rotor pole. The rotor pole flux is the combination of permanent magnet flux and circulating flux in the windings. Ideally, the differential flux motor would operate exclusively on the torque produced by the permanent magnet. The variable reluctance torque produced is twice the frequency and is both positive and negative during the full interval of torque production. The reluctance torque results in zero average torque production over the entire interval but contributes heavily to torque ripple. Techniques used to reduce the variable reluctance torque include using grain-oriented laminations in the rotor to inhibit flux flow in the tangential direction, as well as using rotor punch-outs to inhibit circulating flux in the linear direction, as discussed further below.

Torque production using rotating magnetic stator poles (polyphase distributed phase windings with sinusoidal excitation) will now be explained. A conventional AC motor stator is wound to produce a rotating stator magnetic field when a sinusoidal alternating current source is applied to the stator core windings. The rotating magnetic field produced is effectively equivalent to physically rotating the stator fixed magnetic poles during motor operation. The stator magnetic poles rotate at the frequency of the electrical sinusoidal source applied to the stator core windings. The conventional rotating magnetic field is also used in the differential flux motor. The differential flux motor, operating with sinusoidal excitation, essentially concentrates the permanent magnet flux to a specific area in the motor's airgap in a continuously rotating fashion that is synchronous with the rotor speed.

Torque is produced as the protruding rotor pole rotates in an attempt to maximize the flux flowing through it. The rotor pole effectively chases the rotating area of concentrated permanent magnet flux. As a result, the rotor pole remains fixed in position relative to the rotating stator magnetic pole during steady state operation. The conclusion from the previous discussion of operation with fixed magnetic stator poles was that the permanent magnet flux fluctuates as the rotor pole rotates relative to the stator magnetic pole. The magnitude of flux flowing through the permanent magnet remains constant if the position of the rotor pole remains fixed relative to the stator magnetic pole. Thus, using a rotating magnetic field minimizes the magnitude of flux fluctuation through the permanent magnet during steady state operation.

The steady state orientation of the rotating rotor pole relative to the rotating stator magnetic pole influences the steady state performance of the differential flux motor. As an example, rotor positions that result in increased circulating flux reduce the power factor of the motor. Modern phasor analysis, vector analysis, and D-Q transformations are useful and common mathematical methods for analyzing synchronous AC motor operation. The same analysis methods can also be applied to the differential flux motor operating from an AC sinusoidal power source.

Operation of the differential flux motor with a rotating magnetic field can be similar to conventional AC motors. The principal of operation of the differential flux motor closely parallels that of a conventional synchronous motor (either of the separately excited type or permanent magnet type), with the exception that the differential flux motor contains both magnetic sources on the stator assembly. At first glance, the differential flux motor might appear similar to a conventional synchronous reluctance type motor. However, the operating principle between the two types is fundamentally different. In particular, the synchronous reluctance type motor must produce all the flux flowing in the protruding rotor pole from the stator core windings. This results in a poor input power factor and inefficient operation. Conversely, the differential flux motor steers the permanent magnet bias flux flowing through the rotor pole. Because the permanent magnet is producing the flux flowing through the rotor pole, the differential flux motor has a comparatively high input power factor and efficiency. Construction techniques are intentionally used to minimize production of variable reluctance torque.

The differential flux motor is a synchronous motor. The rotor must chase the rotating magnetic field in synchronism or it will lose the ability to produce unidirectional torque. It can be desirable in many instances to start an electric motor directly off the power grid without the need for special starting devices and methods (e.g., a motor controller). The differential flux motor can accomplish this by incorporating shorted conductors on the rotor similar to conventional induction motors. The principle of starting is almost identical to conventional induction motors and the permanent magnet does not affect the induction process since the permanent magnet flux can be unidirectional, unipolar, and substantially evenly distributed. Thus, the permanent magnet flux flowing through the rotor is invariant with rotor position. Therefore, rotating the rotor mechanically with the stator core windings open circuited does not induce current in the shorted conductors residing on the rotor. Starting current flowing in the windings will produce fluctuating positive and negative differential flux torque until synchronism is achieved. Once synchronism is achieved, currents are no longer induced in the shorted rotor conductors, and no power loss thus occurs in the rotor conductors during normal steady state operation.

The differential flux motor offers many advantages over conventional motors using the mutual flux method of torque production. Most conventional motors use the principle of mutual flux to generate torque. Examples of this class of motor include common AC sinusoidally fed induction and synchronous motors, as well as DC fed brushed motors. All motors of this class contain a magnetic source on both the rotor and stator. Torque is produced when the rotating magnetic source attempts to align in the same polarity as the stationary magnetic source.

As one such advantage, the differential flux motor does not require a magnetic source on the rotating element (i.e.: the rotor). This simplifies the mechanical construction of the rotor. Another benefit is the elimination of electrical power loss required to power a magnetic source residing on the rotor. The result is simplicity, increased efficiency, increased robustness (especially at high speed), and reduced rotor cost.

As another such advantage, stationary permanent magnets attached to the periphery of the motor (e.g., which provide the first and second magnets 122, 132) are conveniently used as the source of mutual flux. The total surface area at the periphery of the motor is greater than the surface area of the rotor. Thus a comparatively larger volume of magnet can be used for a given motor diameter compared to a conventional permanent magnet motor using permanent magnets attached to the rotor. The flux produced by the magnet(s) residing over the entire periphery of the motor becomes concentrated around the protruding rotor pole. This “flux focusing” effect permits the use of low flux, inexpensive, ceramic magnet material, while still producing a high torque, volumetrically efficient, economical motor. Thus, the differential motor can expand the range of power ratings and physical sizes which permanent magnet motors are economically practical.

As still anther such advantage, the differential flux motor can operate on a sinusoidal alternating current source and can thus operate from the same electrical supply as many common conventional electric motors. This contrasts with motors having stationary permanent magnets using doubly salient stators and rotors that cannot operate effectively using a sinusoidal AC current source.

The differential motor also offers multiple advantages over motors using the variable reluctance method of torque production. Examples of this class of motor include switched and synchronous reluctance motors as well as reluctance stepper motors. This class of motors uses saliency of the rotor or stator to achieve variable reluctance of the magnetic path as the rotor rotates. These motors do not use a constant magnetic source such as a permanent magnet. Changing the polarities of the independent sources of magnetic flux on the differential flux motor results in torque production in the opposite direction of rotation. However, changing the polarity of the magnetic flux source on the variable reluctance motor has no effect on the direction of torque production. Hence, the ability to control the direction of torque by changing the polarity of the independent magnetic source in a differential flux motor helps to ensure correct starting rotation and contributes to more efficient torque production. While motor stator core windings of a conventional variable reluctance motor must generate all flux required for motor operation, permanent magnets can be used to provide the constant mutual flux of the differential flux motor. Permanent magnets offer the advantage of lossless magnetic flux production, resulting in increased motor efficiency.

Electrical power losses in the stator core windings constitute the largest contributor of power loss in a motor. Power loss in the stator core windings increases proportionally to the length of the winding. The portion of winding that wraps around the ends of the stator core (end turns) and does not reside within the stator core slots does not contribute to torque production, but contributes to power loss. It is therefore advantageous to minimize the length of windings that is not buried in the slots of the stator core.

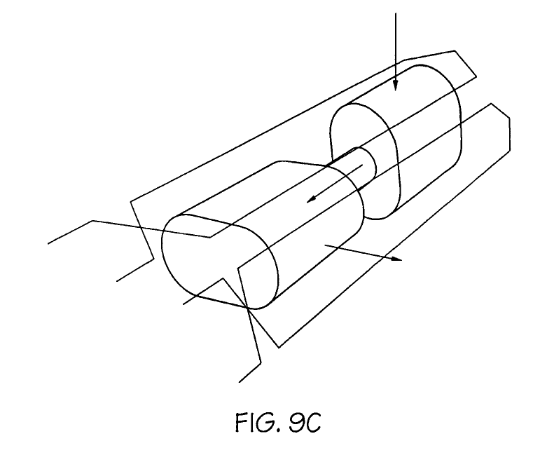

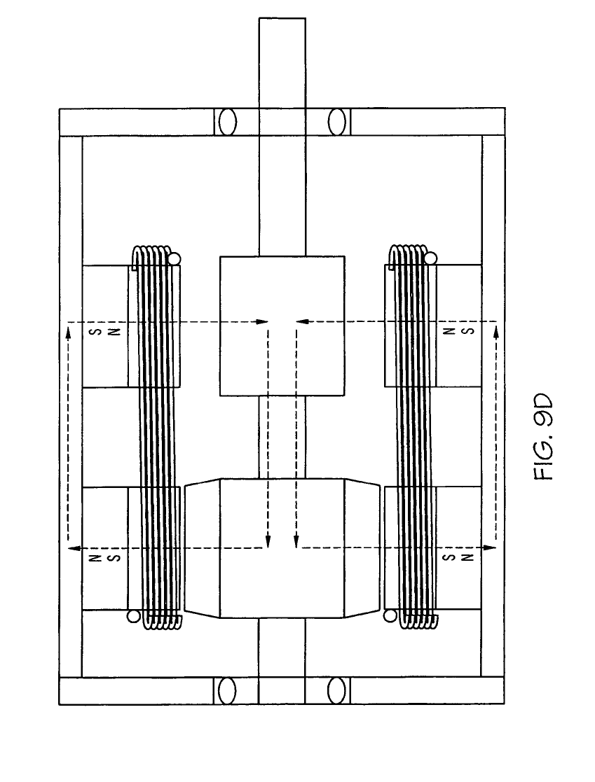

Winding a single winding of wire around both the first and second stator cores (e.g., 116, 126 of FIG. 5A) of a differential flux motor, provided that these stator cores are spaced a small distance apart, reduces the amount of end turns by approximately half, as shown for example in the differential flux motor of FIG. 9C. FIG. 9A depicts a differential flux motor having individual stator core windings for each rotor stack and FIG. 9B depicts a differential flux motor having a single stator core winding. The unipolar magnet flux flows down into the rotor coupled with the north polarity magnet, and flows up the rotor coupled with the south polarity magnet. Therefore, as shown in FIG. 9A, the unipolar magnet flux linking the winding with each rotor is equal in magnitude but flows opposite in direction. If a single winding couples both stators, as shown in FIG. 9B, the unipolar fluxes cancel to thereby produce no net flux linkage through the winding.

FIG. 9C depicts a differential flux motor having a single stator core winding and individual rotor stacks rotated 90 degrees. If the rotor salient poles are oriented 90 degrees respectively, the unipolar flux links the phase winding wound in opposite polarity as shown in FIG. 9C. While the net flux flowing through the winding does not cancel, the opposite winding polarity and flux direction cancel to produce flux linkage of the same polarity for each winding. Orienting the rotor poles 90 degrees apart permits use of a single polarity winding across both stator cores, eliminating half the end turns compared to using two separate windings. FIG. 9D provides a cutaway side view of a differential flux motor having rotors rotated 90 degrees respectively. In such a configuration, flux flows three-dimensionally, and thus flowing perpendicularly out of the paper towards the reader.

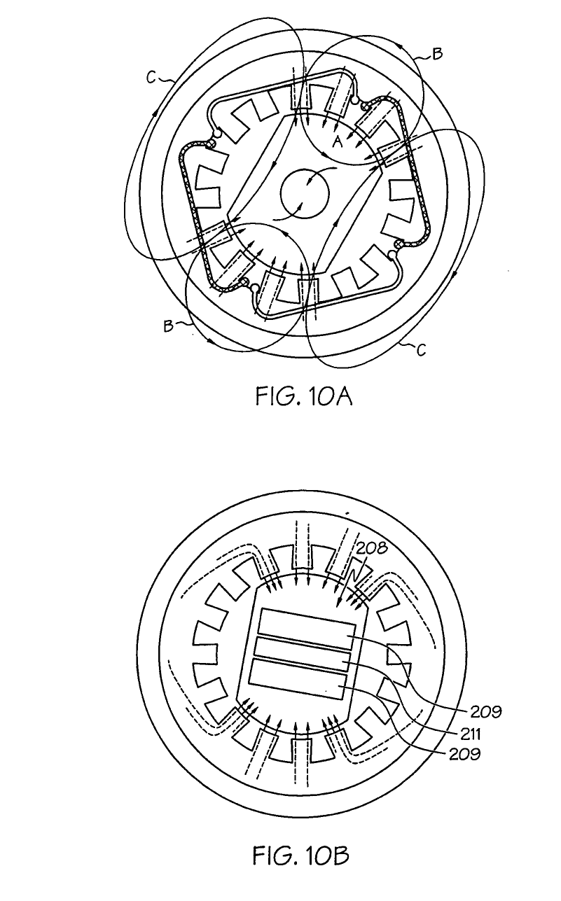

As previously explained and as illustrated in FIG. 10A, three possible paths exist for magnetic flux to flow as the rotor rotates. Path “A” depicts the flux that flows through the permanent magnet and produces continuous torque. Flux path “B” depicts mutually linked stator core winding flux inhibited by use of grain-oriented steel. Flux path “C” depicts mutually linked stator core winding flux inhibited by rotor punch-outs. Flux paths “B” and “C” produce reluctance torque that is twice the frequency of the torque produced by the permanent magnet as the rotor rotates. The positive and negative reluctance torque produced during rotor rotation cancel, resulting in torque ripple, but little net torque production.

To produce smooth continuous torque, it is therefore desirable to retard the amount of reluctance torque produced. Reluctance torque produced by flux path “B” can be reduced by using grain-oriented electrical steel in the rotor. The grain-oriented steel permits flux to flow in one linear direction only, eliminating the flux path “B”. Reluctance torque produced by flux path “C” can be reduced by punching out material at the rotor center. FIG. 10B illustrates the use of a separated rectangular shaft with rotor punch-out for inhibiting flux flow produced by stator core windings. For example, a special shaft 208 can be provided which is formed of rectangular ferromagnetic steel bars 209 which can be magnetically separated by a rotor punch-out area 211 to inhibit flow of flux induced by windings on the stator core. This special shaft 208 can be inserted into the rotor core to provide a path for the unipolar magnet flux of flux path “A” to flow.

The differential flux motor holds promise for significant improvements in economy and efficiency compared to traditional electric motors. The motor can use inexpensive low-energy ceramic ferrite magnets, combined with novel construction techniques, to economically obtain a volumetrically efficient motor. The rotor construction, having two simple salient iron poles void of magnetic excitation, also contributes to the economy and efficiency of the motor.

In one embodiment, the differential flux motor can use a dual stator core and a dual rotor coupled to a single magnetic shaft. Permanent magnet flux circulates between the dual rotor/stator pair via the common shaft. This construction method results in uniform unidirectional permanent magnet flux flow through each individual stator core and its associated phase windings. The motor's unique principle of torque production is based on diverting and concentrating the uniform unidirectional permanent magnet flux to the appropriate location of the motor's airgap to produce torque. The phase windings are electrically energized to concentrate and divert the uniform permanent magnet flux towards the desired airgap location, attracting the protruding rotor pole, and producing mechanical motion. The permanent magnet flux is diverted differentially if negligible change to the net magnitude of permanent magnet flux results from current flow in the stator phase windings.

Equations will hereafter be derived for the differential flux motor. FIG. 11 depicts the spatial coordinate system chosen to derive equations for the differential flux motor and further depicts one phase winding on the stator core of the motor. As shown in FIG. 11, “q” refers to the Q-axis or quadrature axis, “d” refers to the D-axis or direct axis, “r” refers to the rotor axis, “Q” refers to the Q-axis winding wound in opposite polarity, and “D” refers to the D-axis winding connected in series with the Q-axis winding. The rotor position is referenced to the D-axis stator core winding by rotor position angle “θ”. The Q-axis winding is spaced 90 degrees mechanically relative to the D-axis winding. Permanent magnet flux flows radially in the motor along the Z-axis, which in this coordinate system points vertically out of the page toward the reader.

The following analysis is based upon the following approximations and justifications. First, the permanent magnet flux is constant. This is valid if the thickness of the magnet is much greater than the airgap thickness and if the electrical loading of the motor is within its ratings. Second, the magnetic medium has infinite permeability. This is valid if high permeability electrical steel is used and of sufficient thickness to prevent saturation from occurring under rated electrical loading levels. Third, fringing at the rotor corners is neglected. This is valid if the rotor is constructed of grain-oriented steel laminations.

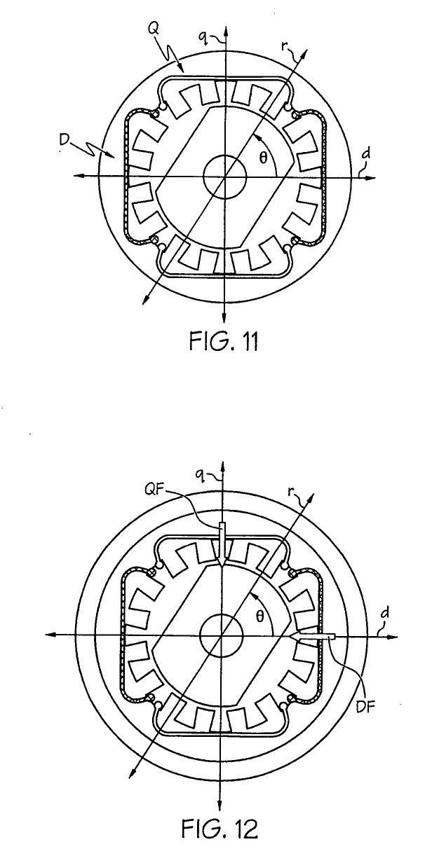

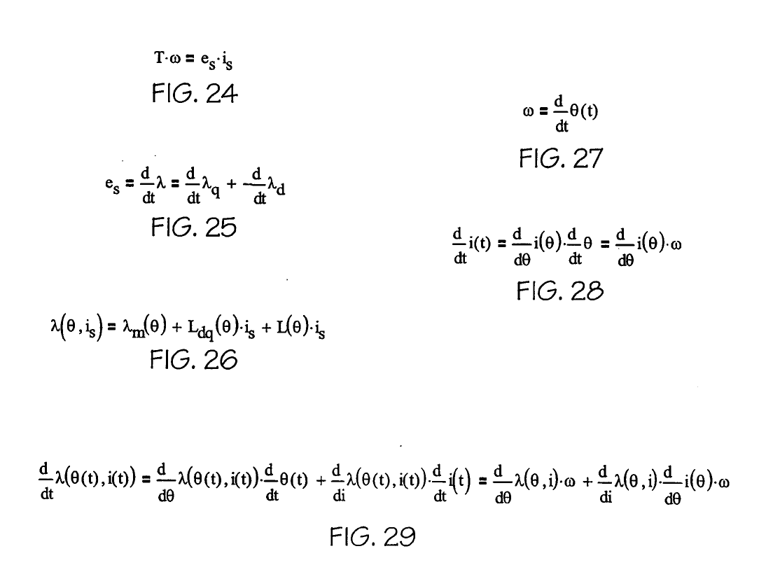

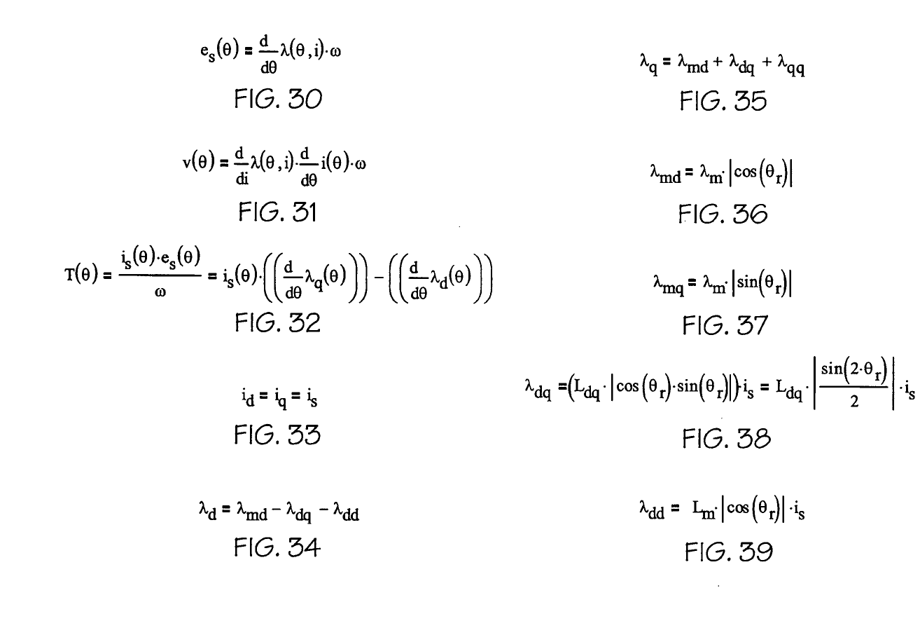

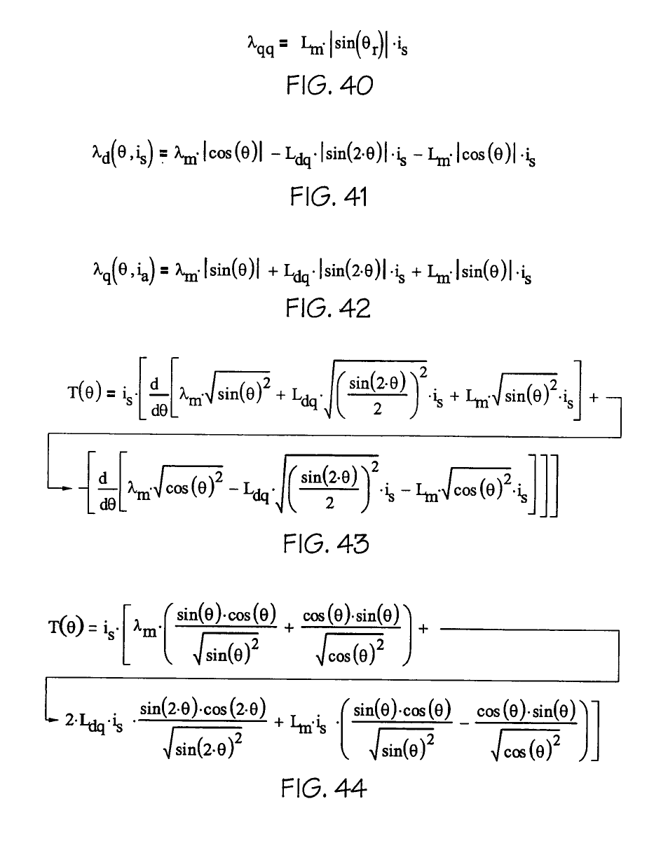

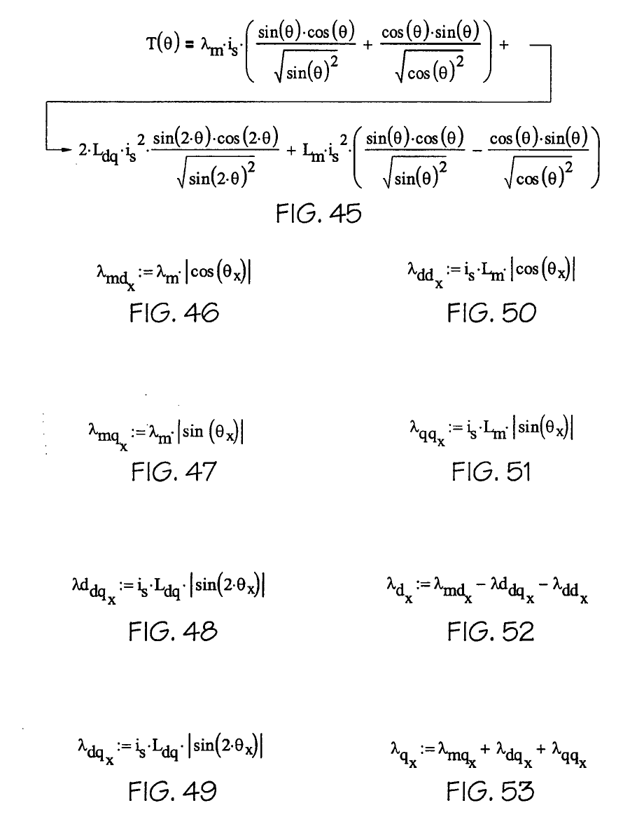

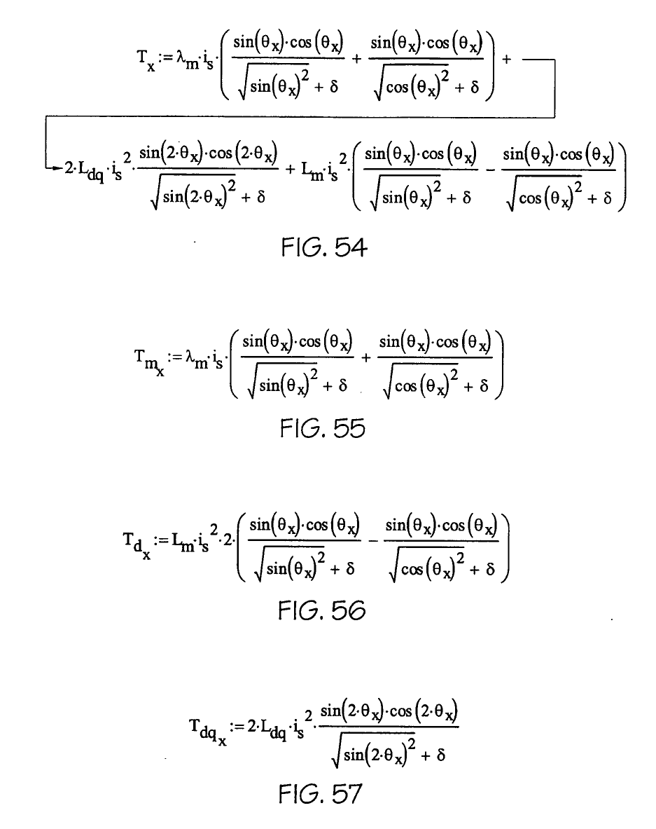

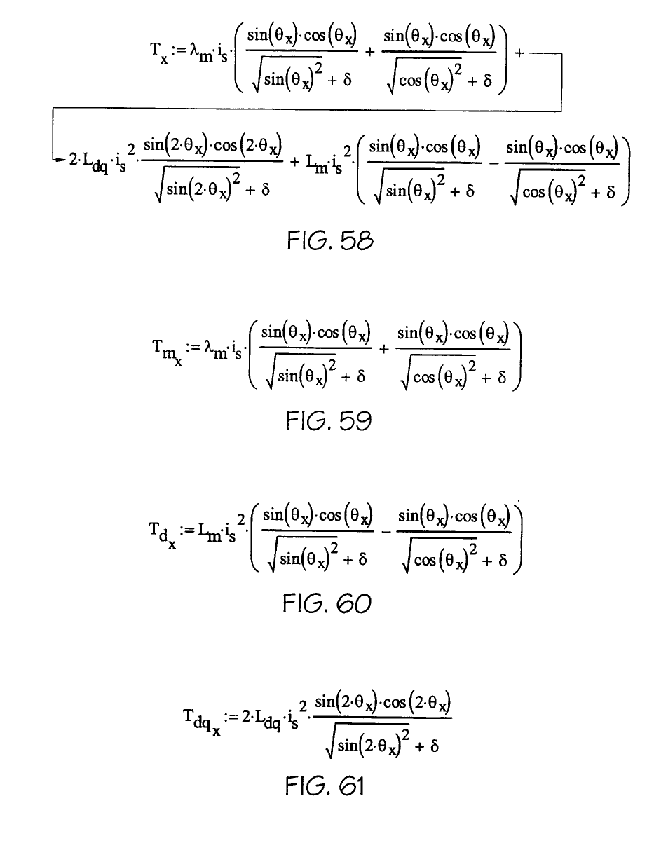

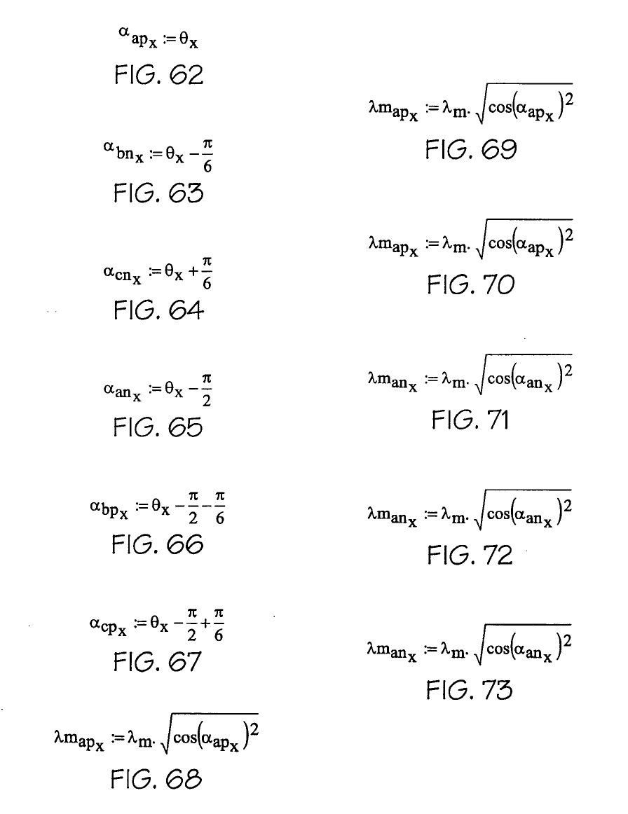

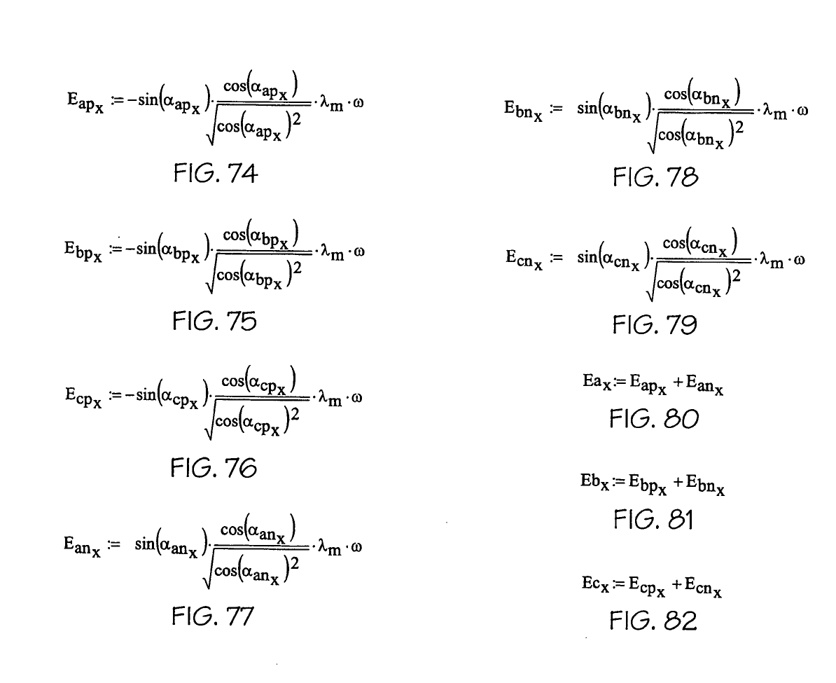

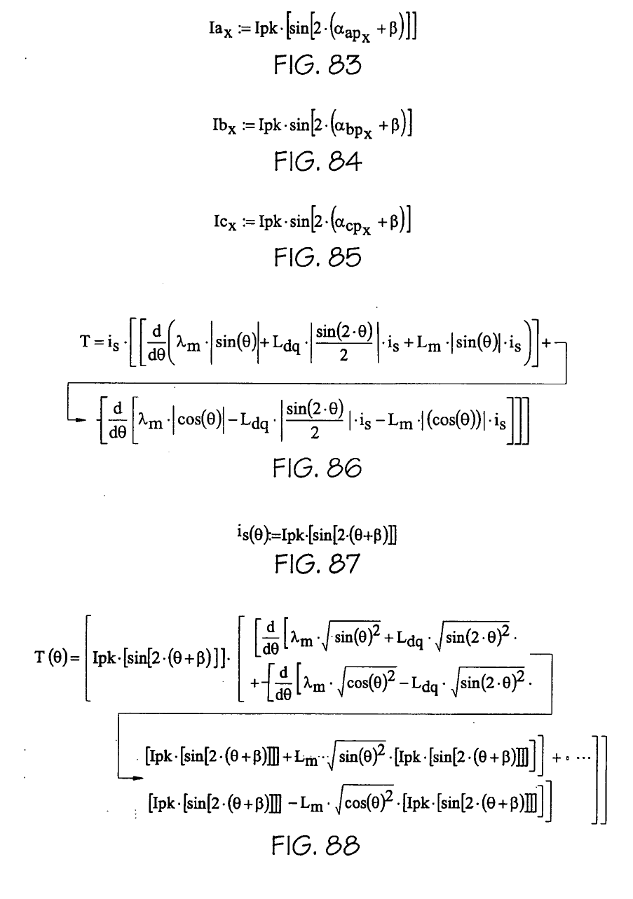

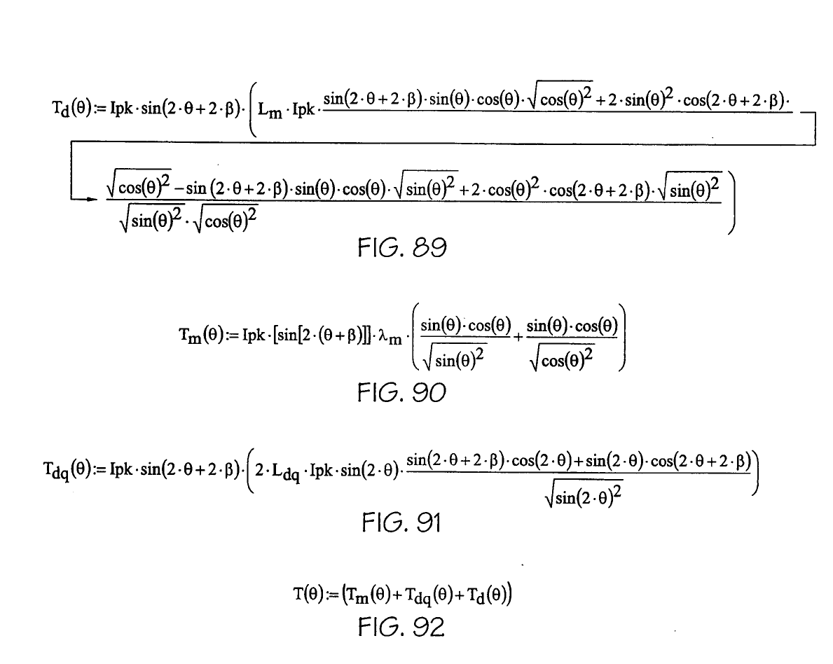

The equations describing the differential flux motor are based on certain base equations. The first of these equations is depicted in FIG. 24 and is a conservation of energy equation relating to the electrical airgap power equaling the mechanical output power over neglecting losses. In this equation, “T” is shaft torque, “ω” is shaft velocity, “eₛ” is stator core winding back electromotive force, and “iₛ” is stator core winding current. Faraday's law is another key equation, is shown in FIG. 25, and relates to the voltage induced in the winding being equal to the rate of change of flux linking the stator windings. Faraday's law as shown in FIG. 25 is based upon the windings being connected in series, although a sign reversal would occur if the windings were wound in an opposite direction. “λ_{d}” is flux linkage for the reference winding (D-axis). “λ_{q}” is flux linkage for a winding placed 90 degrees apart, connected in series, and wound in an opposite direction (Q-axis). Q-axis flux is shown as “QF” in FIG. 12, and D-axis flux is shown as “DF” in FIG. 12.

Flux linkage through any winding is the sum of permanent magnet flux, generated flux mutually linking the other winding (mutual flux), and generated flux linking the stator core itself (self-induced flux). The flux linkage is dependent on stator winding current and rotor position. FIG. 26 depicts an equation involving flux linking an individual winding combination of magnet flux and self-induced and mutual flux produced by current flowing through windings. In this equation, “λₘ” is permanent magnet flux, “L” is self-inductance, “θ” is rotor position, “iₛ” is stator core current, and “L_{dq}” is mutual inductance. Flux linkage of permanent magnet flux through individual stator core windings varies with the amount of rotor overlap under the individual stator core winding. The direction of flux is constant and is determined by magnet polarity. Referencing FIG. 13, the permanent magnet flux enters along the peripheral shell of the motor from the Z-axis and exits through the rotor shaft along the Z-axis.

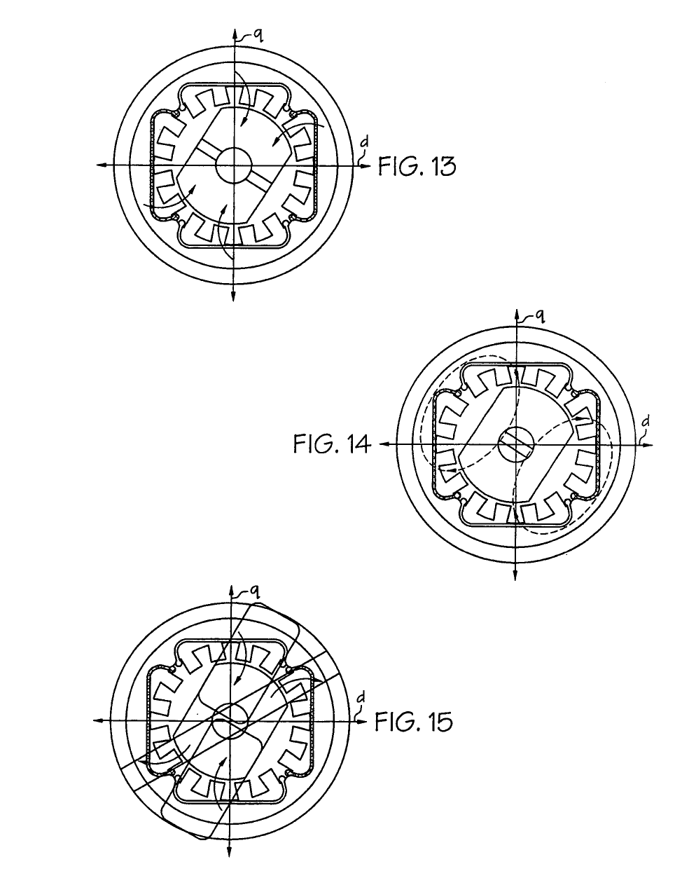

Referring to FIG. 14, flux linkage mutually circulating between stator core windings is generated by current flow in the stator core windings. The direction of the flux is determined by the polarity of stator core winding current. The magnitude is determined by rotor position and magnitude of stator core winding current. Referring to FIG. 15, self-induced flux from each winding flows along the same path as the permanent magnet flux. The direction of flux is determined by stator core winding current polarity. The magnitude of flux is determined by rotor position and magnitude of stator core winding current.

FIG. 27 is an equation relating the shaft velocity to the rate of change of rotor position. Phase current is referenced relative to rotor position for a synchronous motor in the equation of FIG. 28, wherein differentiation is by parts of phase current with respect to rotor position. The rate of change of flux linkage varies as phase current and rotor position varies, as shown by the equation of FIG. 29, wherein differentiation is by parts of flux linkage with respect to rotor position and phase current. Electrical energy consists as distinct forms as shown by the equation of FIG. 30 which involves electrical energy converted to mechanical power, and as shown by the equation of FIG. 31 which involves stored circulating electrical energy. Now, substituting the equations of FIGS. 25-28 and 30-31 into the equation of FIG. 24, an equation describing torque produced is attained, as shown in FIG. 32.

Equations also describe linkages among flux induced by windings on the stator core. FIG. 33 depicts an equation in which stator windings for one phase are connected in series and current flow is the same in all windings. FIG. 34 depicts an equation involving the total flux flowing through the winding aligned with the direct axis, wherein flux generated by the winding current is of opposite polarity to that of the magnet flux for positive stator winding current. FIG. 35 depicts an equation involving the total flux flowing through the winding aligned with the quadrature axis, wherein flux generated by the winding current is of the same polarity as magnet flux for positive stator winding current. FIGS. 36 and 37 depict equations in which the portion of magnet flux linking each stator core winding current depends on the amount of rotor overlap with the stator winding (see FIG. 13). FIG. 38 depicts an equation involving generated mutual flux linking both quadrature and direct phase windings, wherein the mutual flux is a product of rotor overlap of both windings (see FIG. 14). FIG. 39 shows an equation wherein the generated self-induced flux of the stator core winding aligned with the direct axis depends upon the stator core winding current and rotor overlap. FIG. 40 shows an equation wherein the generated self-induced flux of the stator core winding aligned with the quadrature axis depends upon the stator core winding current and rotor overlap (see FIG. 15). FIG. 41 depicts an equation substituting in equations for direct axis flux. FIG. 42 depicts an equation substituting in equations for quadrature axis flux. FIG. 43 depicts the equations of FIGS. 41-42 being substituted into the derived torque equation of FIG. 32. Referencing FIG. 44, to obtain a torque equation for a given rotor position, the differential equation is solved holding phase current constant (iₛ(θ)=constant; d/dθ iₛ(θ)=0). The terms are collected for the final torque equation in terms of constant phase current and rotor position, as shown in FIG. 45.

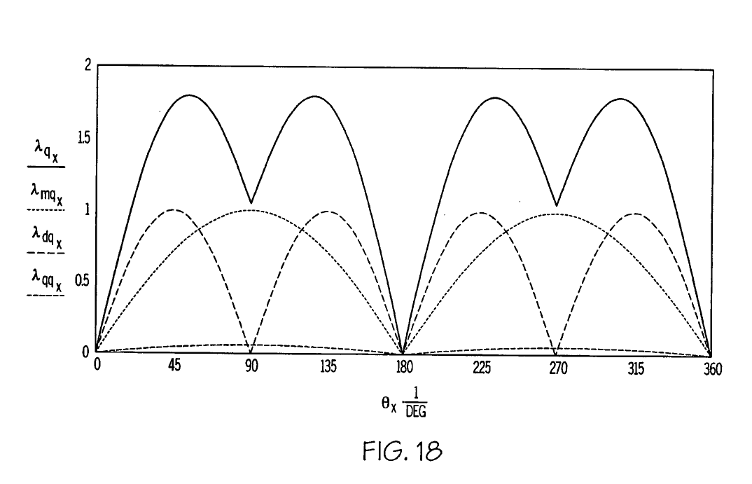

A stationary stator reference frame flux linkage graph can be calculated. The range of rotor rotation over one complete cycle is x:=0.360, θₓ:=(x)(deg). Values are assigned for the calculation as follows: λₘ=1 Wb; iₛ=5 amp; Lₘ=0.01 H; L_{dq}:=(20)(Lₘ); and ω:=1 rad/sec. The permanent magnet flux linkage is shown by the equation of FIG. 46 for the direct axis winding, and by the equation of FIG. 47 for the quadrature axis winding. The mutual flux linkage is shown by the equation of FIG. 48 for the direct axis winding, and by the equation of FIG. 49 for the quadrature axis winding. The reaction flux linkage is shown by the equation of FIG. 50 for the direct axis winding, and by the equation of FIG. 51 for the quadrature axis winding. The total stator core winding flux linkage is shown by the equation of FIG. 52 for the direct axis winding, and by the equation of FIG. 53 for the quadrature axis winding. FIG. 18 provides a graph of quadrature axis flux linkages as the rotor rotates.

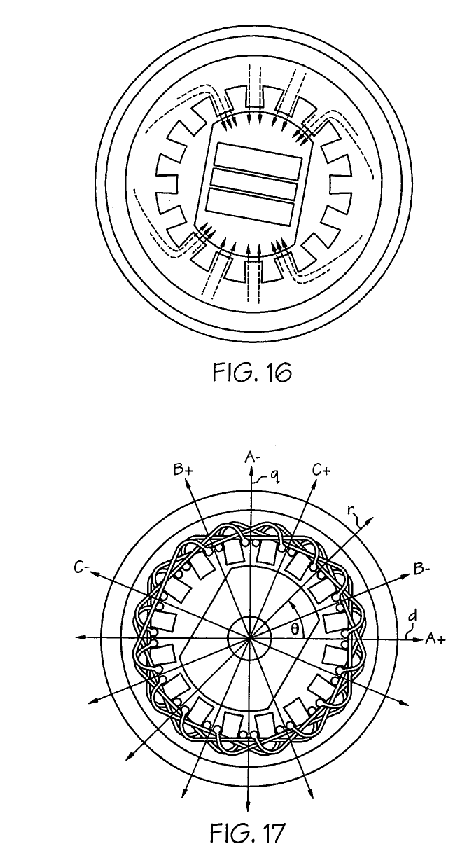

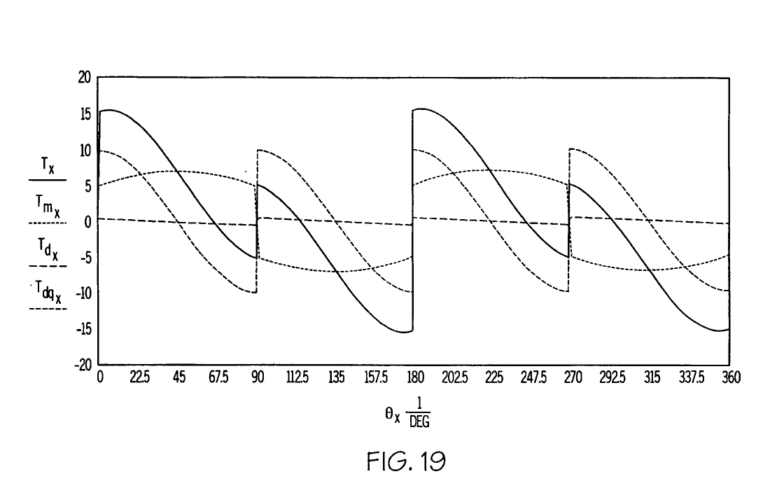

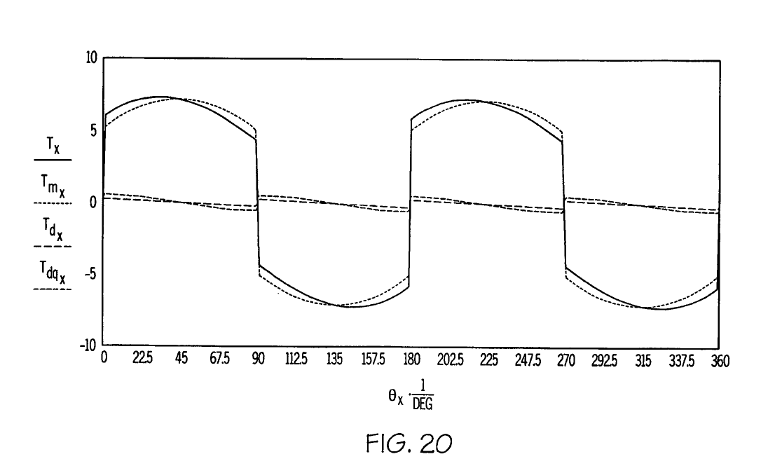

The equation of FIG. 54 relates to the phase torque produced for constant applied phase current as the rotor position varies, and the equation of FIG. 55 highlights the differential flux torque component, FIG. 56 highlights the reaction flux torque component, and FIG. 57 highlights the reluctance torque component (δ=1×10⁻¹²). FIG. 19 provides a graph of phase torque produced for constant applied phase current as the rotor rotates. The equation of FIG. 58 relates to phase torque, and the equation of FIG. 59 highlights the differential flux torque component, FIG. 60 highlights the reaction flux torque component, and FIG. 61 highlights the reluctance torque component. The graph of FIG. 19 displays torque produced by the direct axis winding with phase winding current held constant as rotor position varies. The reluctance torque is twice the frequency of the differential flux torque component and contributes heavily to torque ripple. With reference to FIG. 16, the reluctance torque can be reduced by constructing barriers to the flow of circulating flux, thereby reducing the value of stator winding mutual inductance L_{dq}. Barriers are constructed by using oriented steel in the rotor to prevent tangential flow of flux through the rotor. Also, slots can be punched in the center of the rotor to impede the flow of circulating flux without inhibiting the flow of axial permanent magnet flux. L_{dq} can be reduced using grain oriented rotor laminations and a center punch-out (i.e.: L_{dq}=1×Lₘ). FIG. 20 depicts a graph of phase torque produced with the reduced reluctance torque component.

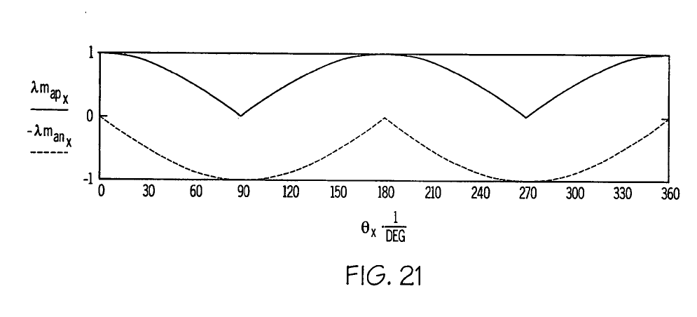

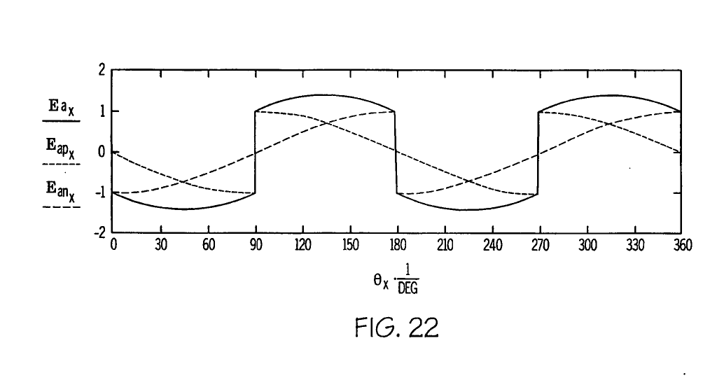

Three phase sinusoidal AC operation will now be discussed with respect to FIG. 17. The stator uses a standard four pole sinusoidally distributed winding configuration for operation of the differential flux motor from a sinusoidal alternating current power source. FIG. 17 illustrates winding orientation for a three phase motor, wherein “A+” refers to the Phase A+axis, “A−” refers to the Phase A− axis, “B+” refers to the Phase B+axis, “B-” refers to the Phase B− axis, “C+” refers to the Phase C+axis, and “C−” refers to the Phase C− axis. The “+” signs designate that winding polarity is oriented so flux flows toward the rotor when current flows positive in the stator phase winding. The “−” signs indicate opposite winding polarity from the “+” signs. Each phase winding is shown in FIG. 17 to be oriented 30 mechanical degrees apart. The rotor axis is referenced to each winding by the equations shown in FIGS. 62-67, and the permanent magnet flux flowing through a given phase winding is set forth in the equations of FIGS. 68-73. FIG. 21 provides a graph depicting the permanent magnet flux linking phase “A” windings aligned with both the direct and quadrature axis as the rotor rotates. The voltage induced on the windings due to rotor rotation and permanent magnet flux can be calculated according to Faraday's law, and is shown in the equations of FIGS. 74-82. FIG. 22 provides a graph of back electromotive force voltages induced on phase windings as a result of permanent magnet flux and rotor rotation.

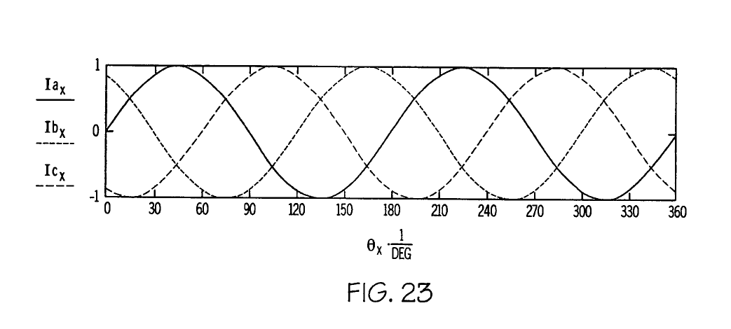

The frequency of the generated voltage completes two cycles for every complete rotation of the rotor because the differential motor contains two rotor poles. As with all synchronous motors, the applied electrical frequency must be synchronous with the rotor radial velocity to maintain constant torque output. The motor phase currents should be applied in phase with the generated motor voltages to maximize power output from the motor. Assuming β:=0 rad (phase angle of current to phase voltage) and Ipk:=1 amp, the equations for the applied phase currents are shown in FIGS. 83-85. The graph of FIG. 23 charts these phase currents as a function of rotor rotation.

Referring to FIG. 86, and assuming β:=0 deg, Lₘ=0.001 H, L_{dq}=5×Lₘ, and Ipk:=10 amp, the torque equation can be derived for one phase winding for sinusoidal current applied to phase windings using the equation of FIG. 43 above. FIG. 87 depicts an equation in which sinusoidal phase current is applied synchronously to rotor position and β is the phase angle between phase current and rotor position. FIG. 88 portrays an equation in which the equation of FIG. 86 has been substituted into the equation of FIG. 87. The equation of FIG. 88 is then separated into torque components, wherein the reaction torque term is shown in FIG. 89, the differential flux torque term is shown in FIG. 90, and the reluctance torque term is shown in FIG. 91. The sum of torques produced is then shown in the equation of FIG. 92.

The foregoing description of embodiments and examples of the invention has been presented for purposes of illustration and description. It is not intended to be exhaustive or to limit the invention to the forms described. Numerous modifications are possible in light of the above-teachings. Some of those modifications have been discussed and others will be understood by those skilled in the art. The embodiments were chosen and described in order to best illustrate the principles of the invention and various embodiments as are suited to the particular use contemplated. The scope of the invention is, of course, not limited to the examples or embodiments set forth herein, but can be employed in any number of applications and equivalent devices by those of ordinary skill in the art. Rather it is hereby intended the scope of the invention be defined by the claims appended hereto.

1. A differential flux motor comprising:
a rotor comprising at least one rotor section and a shaft, said rotor section attached to the shaft;
a stator assembly comprising:
a first stator core including a first winding, the first stator core concentrically surrounding at least a first portion of the rotor;
a second stator core having a second winding, the second stator core concentrically surrounding at least a second portion of the rotor, the second portion being different from the first portion;
a first magnet concentrically surrounding at least part of the first stator core, the first magnet being formed from permanent magnet material and having a first polarity;
a second magnet concentrically surrounding at least part of the second stator core, the second magnet being formed from permanent magnet material and having a second polarity; and
a shell concentrically surrounding at least part of each of the first magnet and the second magnet.

2. The motor of claim 1 wherein the stator assembly further comprises a first magnetic conductor ring concentrically disposed between the first stator core and the first magnet.

3. The motor of claim 2 wherein the stator assembly further comprises a second magnetic conductor ring concentrically disposed between the second stator core and the second magnet.

4. The motor of claim 3 wherein the second magnetic conductor ring is spaced from the first magnetic conductor ring.

5. The motor of claim 1 wherein the rotor comprises a first rotor section and a second rotor section, the first rotor section and the second rotor section being spaced from one another, the first stator core concentrically surrounding at least part of the first rotor section, and the second stator core concentrically surrounding at least part of the second rotor section.

6. The motor of claim 5 wherein each of the first rotor section and the second rotor section comprises a salient pole rotor.

7. The motor of claim 1 wherein the stator assembly further comprises a spacer disposed between the first magnet and the second magnet.

8. The motor of claim 7 wherein the stator assembly further comprises a first magnetic conductor ring and a second magnetic conductor ring, the first magnetic conductor ring being concentrically disposed between the first stator core and the first magnet, the second magnetic conductor ring being concentrically disposed between the second stator core and the second magnet, and the first magnetic conductor ring being spaced from the second magnetic conductor ring by the spacer.

9. The motor of claim 8 wherein the spacer is further disposed between the first stator core and the second stator core.

10. The motor of claim 9 wherein the rotor comprises a first rotor section and a second rotor section, the first rotor section and the second rotor section being spaced from one another by the spacer and being attached to the shaft, the first stator core concentrically surrounding at least part of the first rotor section, and the second stator core concentrically surrounding at least part of the second rotor section.

11. The motor of claim 1 wherein the first winding and the second winding are configured to receive three phase alternating current for use in facilitating powered rotation of the rotor.

12. The motor of claim 1 wherein the first winding and the second winding are configured to receive three phase alternating current having a substantially sinusoidal waveform for use in facilitating powered rotation of the rotor.

13. The motor of claim 1 wherein the first polarity is directed inwardly from the first magnet toward the shaft and the second polarity is directed outwardly from the second magnet toward the shell.

14. The motor of claim 1 wherein the shell comprises rolled steel and said rotor section comprises a plurality of laminations.

15. The motor of claim 1 wherein the second magnet is spaced from the first magnet

16. A differential flux motor configured to receive three phase alternating current having a substantially sinusoidal waveform, the motor comprising:
a rotor comprising a first rotor section, a second rotor section, and a shaft, wherein the first rotor section and the second rotor section are spaced from one another along a longitudinal length of the shaft, and wherein the first rotor section and the second rotor section are each attached to the shaft;
a stator assembly comprising:
a first stator core including a first winding, the first stator core concentrically surrounding at least part of the first rotor section;
a second stator core having a second winding, the second stator core concentrically surrounding at least part of the second rotor section;
a first magnet concentrically surrounding at least part of the first stator core, the first magnet being formed from permanent magnet material and having a first polarity;
a second magnet concentrically surrounding at least part of the second stator core, the second magnet being formed from permanent magnet material and having a second polarity, and the second magnet being spaced from the first magnet; and
a first magnetic conductor ring concentrically disposed between the first stator core and the first magnet;
a second magnetic conductor ring concentrically disposed between the second stator core and the second magnet, wherein the second magnetic conductor ring is spaced from the first magnetic conductor ring; and
a shell concentrically surrounding at least part of each of the first magnet and the second magnet.

17. The motor of claim 16 wherein the stator assembly further comprises a spacer disposed between at least one of:
(a) the first magnet and the second magnet;
(b) the first magnetic conductor ring and the second magnetic conductor ring;
(c) the first stator core and the second stator core; and
(d) the first rotor section and the second rotor section.

18. The motor of claim 16 wherein the first polarity is directed inwardly from the first magnet toward the shaft and the second polarity is directed outwardly from the second magnet toward the shell.

19. A method of manufacturing a differential flux motor, the method comprising:
providing a rotor by connecting a first rotor section and a second rotor section to a shaft such that the first rotor section is spaced from the second rotor section;
surrounding at least part of the first rotor section with a first stator core having a first winding;
surrounding at least part of the second rotor section with a second stator core having a second winding;
surrounding at least part of the first stator core with a first magnet formed from permanent magnet material and having a first polarity;
surrounding at least part of the second stator core with a second magnet formed from permanent magnet material and having a second polarity;
surrounding at least part of each of the first magnet and the second magnet with a shell; and
rotatably supporting the rotor with respect to the first stator core, the second stator core, the first magnet, the second magnet, and the shell.

20. The method of claim 19 further comprising providing a first magnetic conductor ring between the first stator core and the first magnet, and providing a second magnetic conductor ring between the second stator core and the second magnet.
